(19) United States
(12) Patent Application Publication
(10) Pub. No.: US 2009/0157452 A1
(43) Pub. Date: Jun. 18, 2009

(54) POLICY AND CONTRACT COMPLIANCE SYSTEM AND METHOD

(75) Inventors: Rohit Arora, Harrison, NJ (US); Bobby Chetal, Gurgaon (IN); Amit Sakhuja, New Delhi (IN)

Correspondence Address: Snell & Wilmer L.L.P. (AMEX), ONE ARIZONA CENTER, 400 E. VAN BUREN STREET, PHOENIX, AZ, 85004-2202, US

(73) Assignee: American Express Travel Related Services Company, Inc., New York, NY (US)

(21) Appl. No.: 12/033,115

(22) Filed: Feb. 19, 2008

Related U.S. Application Data
(60) Provisional application No. 61/014,287, filed on Dec. 17, 2007.

(51) Int. Cl. G06Q 10/00; G06F 17/30

(52) U.S. Cl. 705/7; 707/102; 707/E17.009

(57) ABSTRACT

An integrated tool captures institutional and expert knowledge, then stores policy exclusion rules used to evaluate and enforce legal, regulatory, business and contract policy. Rules driven intelligent user interfaces enable efficient, validated and standardized entry of both policy exclusion rules and business operations plans to increase time and cost efficiency and lower risk. A rules engine evaluates business operation plans and identifies policy exclusions that should be enforced. A management information system automates methods and integrates tools to provide a tangible, integrated system.

### RELATED APPLICATIONS

This application claims priority to, and the benefit of, U.S. Provisional Ser. No. 61/014,287 filed on Dec. 17, 2007 and entitled AUTOMATED POLICY AND CONTRACT COMPLIANCE SYSTEM AND METHOD, which is hereby incorporated by reference.

### FIELD OF THE INVENTION

The present invention generally relates to identifying and enforcing legal, regulatory, business and contractual policies applicable to a business operation. More particularly, the invention includes an integrated, end-to-end direct marketing campaign restriction identification system and method.

### BACKGROUND OF THE INVENTION

The direct marketing industry is governed by complex laws and regulations where non-compliance can often cause significant penalties and legal repercussions. These legal and regulatory requirements vary from, for example, “Do Not Call” regulations to other regulations related to the sharing of customer data between affiliates and third parties without customer consent. In addition to laws and regulations, direct marketing organizations also typically enforce business rules and contract compliance rules when preparing target lists for their direct marketing campaigns. For example, a direct marketing organization may wish to restrict offers to customers that have a certain credit history or the direct marketing organization may be restricted by a contract with a marketing partner from marketing in a particular way to certain customers. As such, businesses devote considerable resources to identifying and enforcing legal, regulatory, business and contractual policies and to ensuring that the policies are enforced in their business operations.

In the past, determining regulatory, legal, business and contact restrictions applicable to a specific type of business operation, such as a direct marketing campaign, was a cumbersome, manual process. The process typically involved written guidelines, extensive training programs, significant work hours and often consultation with privacy and legal experts. Moreover, the process was costly, slow and often produced inaccurate results. Significantly, the process expected marketing partners to understand these complex restrictions or to engage in numerous communications with the direct marketing organization before the correct set of restrictions for a particular marketing campaign could be identified. Therefore, a long-felt need exists to streamline and automate this overall process, along with improvements to the process, that produce reduced risk and reduced costs for the organizations involved in the process.

### SUMMARY OF THE INVENTION

The present invention improves upon existing systems and processes by providing a tangible, integrated, end-to-end direct marketing request and restriction identification transformation. In one embodiment, the invention provides policy identification and automated eligibility evaluation systems and methods that allow organizations to capture institutional and expert knowledge, and leverage it to streamline high-risk and resource intensive processes. A management information system provides end users access to several different interfaces and to a rules-based engine that evaluates and enforces policy rules that have been captured by other modules and interfaces enabled by the invention.

In one embodiment, the system automatically generates the applicable restrictions based on certain parameters which are entered by the end-user via an intelligent user interface. The system allows the user to perform one or more of the following: produce policy exclusion lists, produce target population lists, create eligibility files and other customer marketing files, track the progress of a campaign list request, store campaign list request documentation, check the status of a campaign list request, create membership rewards, co-brand points, statement credit, fulfillment requests and/or request market research surveys.

In one embodiment, the system includes: (i) an interface for specifying and updating legal, regulatory, business and contract policies; (ii) storage of the policies in a database or other central repository; (iii) an interface for marketing partners to specify a marketing campaign; (iv) an integrated rules engine that identifies restrictions given a particular set of request parameters; (v) generating direct marketing campaign specific restrictions; (vi) communication of the resultant restrictions to the direct marketing organization's customer database; and, (vii) methods for the implementation and enforcement of specific legal, regulatory, business and contract policies.

### BRIEF DESCRIPTION OF THE DRAWINGS

A more complete understanding of the invention may be derived by referring to the detailed description and claims when considered in connection with the Figures, wherein like reference numbers refer to similar elements throughout the Figures, and:

FIG. 1 is an overview of a representative system for providing an automated request that identifies and enforces predefined policy rules, in accordance with an embodiment of the present invention.

FIG. 2 is a representative process flow diagram for defining and storing policy rules, in accordance with an embodiment of the present invention.

FIG. 3 is a representative process flow diagram for entering a marketing campaign request, in accordance with an embodiment of the present invention.

FIG. 4 is a representative process flow diagram for dynamically generating graphical user interface prompts depending on the type of marketing campaign, in accordance with an embodiment of the present invention.

FIG. 5 is a representative process flow diagram for applying rules engine logic to generate policy exclusions for a marketing campaign, in accordance with an embodiment of the present invention.

### DETAILED DESCRIPTION OF EXEMPLARY EMBODIMENTS

The detailed description of exemplary embodiments of the invention herein makes reference to the accompanying drawings, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In one embodiment, the system includes a graphical user interface (GUI), a software module, a rules engine, and numerous databases. While the system may contemplate upgrades or reconfigurations of existing processing systems, changes to existing databases and business information system tools are not necessarily required by the present invention. For example, the present system may contemplate, but does not require a contract policy exclusion database. Moreover, the system may be seamlessly integrated into existing information technology and data management architectures and business information system tools with minimal changes to existing systems.

The system is useful for at least two different types of users. Policy experts use the system to define policy rules for enforcement of, for example, legal, regulatory, business and/or contract constraints. A rules engine accessing the centrally maintained policy exclusion data dynamically generates GUIs that prompt the user to enter the information to fully or partially evaluate and enforce policy exclusions. The GUI of the system is controlled by a rules engine that accesses specific methods to prompt the policy expert to, for example, input the data that is used to evaluate and enforce the policy, specify rules, specify actions to be taken when rules are violated, reconcile conflicting, illogical or logically impossible rules, and/or the like. A second type of user is the marketing partner user. In one embodiment, the marketing partner user fully or partially specifies a marketing campaign. As used herein, a marketing partner is any individual, entity, software and/or hardware (internal or external to the direct marketing organization) that plans and/or implements marketing plans.

Exemplary benefits provided by this invention include improvements in the areas of governance, process standardization and automation. The invention improves upon existing solutions because it does not require marketing partners to have a complete understanding of the numerous legal/regulatory/business/contractual policies when specifying a new direct marketing campaign. The tool enables the marketing partners to submit the requests in a very simplified manner along with governance around it. In addition to process improvement/automation benefits, this invention also prevents losses due to potential law suits as a result of improper/lack of compliance to legal/regulatory/contractual and business requirements. A single violation of “Do Not Call” requirement can result in a fine of $ 1,100, a subsequent violation doubling the amount and potential for a company to lose its ability to conduct telemarketing if violations continue.

Moreover, the invention provides improvements for direct marketing organizations in many aspects of their business including: i) Governance—Policies are automatically enforced unless an authorized user overrides the system. Reports are generated on overrides and are further evaluated and confirmed by a separate team; ii) Potential losses—The potential losses from marketing to inappropriate customers is reduced as the business policies relating to marketing to high-risk customers is implemented in the rules engine; iii) Compliant direct marketing efforts—Compliant marketing campaigns result in an improved control environment for direct marketing organizations as well as a positive customer experience; and/or iv) Avoidance of potential legal issues—Each of the legal and regulatory policy infringements produces legal and monetary risk for the organization. Because of this invention, adherence to legal/regulatory policies is assured.

While described herein in reference to identifying and enforcing policy rules for a marketing campaign, practitioners will appreciate that the invention may further be implemented to increase speed, lower cost and enhance the quality associated with identifying and/or enforcing policies in a wide variety of business functions. For instance, one embodiment may identify and enforce policy and eligibility rules for a government grant program. Other examples of such policy identification and automated eligibility evaluation techniques may be accomplished through a variety of computing resources and hardware infrastructures.

While the description makes reference to specific technologies, system architectures and data management techniques, practitioners will appreciate that this is but one embodiment and that other devices and/or methods may be implemented without departing from the scope of the invention. Similarly, while the description makes frequent reference to a web client, practitioners will appreciate that other examples of policy identification and automated eligibility evaluation methods may be accomplished by using a variety of user interfaces including handheld devices such as personal digital assistants and cellular telephones. Practitioners will also appreciate that a web client is but one embodiment and that other devices and/or methods may be implemented without departing from the scope of the invention.

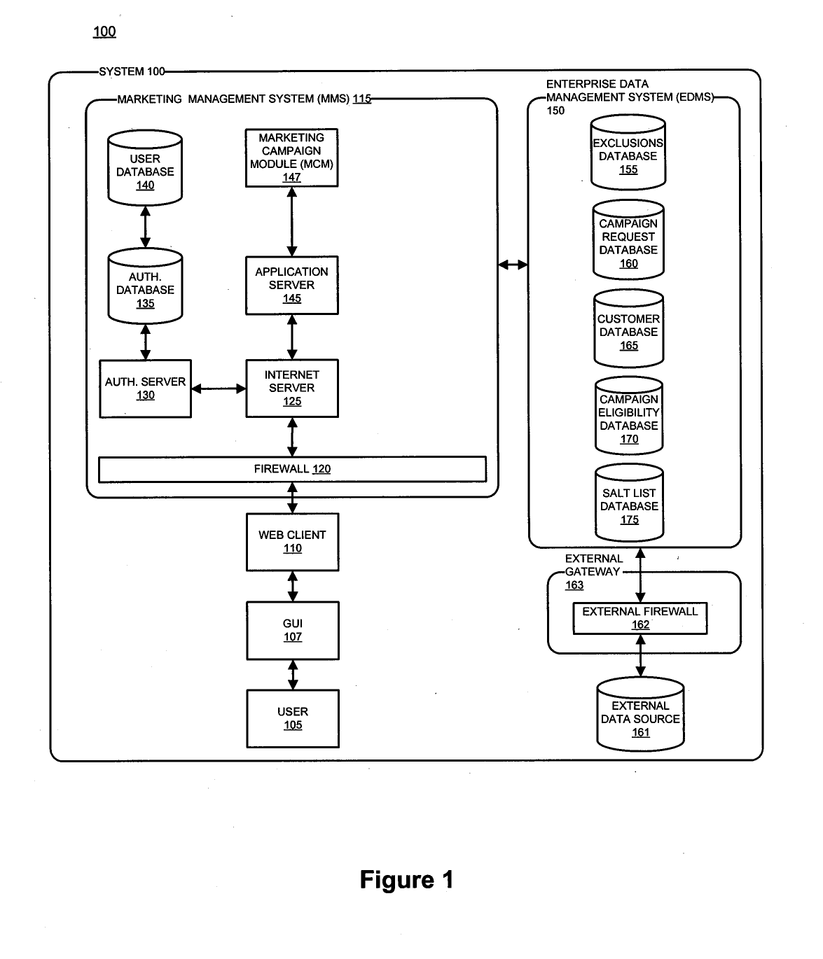

With reference to FIG. 1, the system includes a user 105 interfacing with a marketing management system (“MMS”) 115 by way of a web client 110. While described in the context of information systems for a marketing organization, practitioners will appreciate that the present invention may be similarly used in the context of providing business information and tools for any function (e.g., business, charity, organization, etc.) However, to simplify the explanation, the policy identification and automated eligibility evaluation functions are often referenced herein in the context of identifying and enforcing policy rules for a marketing campaign and providing a system to deliver the data to the user 105 (e.g., a member of a marketing department).

Transmissions between the user 105 and the Internet server 125 may pass through a firewall 120 to help ensure the integrity of the MMS 115 components. Practitioners will appreciate that the invention may incorporate any number of security schemes or none at all. In one embodiment, the Internet server 125 receives page requests from the web client 110 and interacts with various other system 100 components to perform tasks related to requests from the web client 110. Internet server 125 may invoke an authentication server 130 to verify the identity of user 105 and assign specific access rights to user 105. Authentication database 135 may store information used in the authentication process such as, for example, user identifiers, passwords, access privileges, user preferences, user statistics, and the like. When a request to access system 100 is received from Internet server 125, Internet server 125 determines if authentication is required and transmits a prompt to the web client 110. User 105 enters authentication data at the web client 110, which transmits the authentication data to Internet server 125. Internet server 125 passes the authentication data to authentication server which queries the user database 140 for corresponding credentials. When user 105 is authenticated, user 105 may access various applications and their corresponding data sources.

When user 105 logs on to an application, Internet server 125 may invoke an application server 145. Application server 145 invokes logic in the marketing campaign module (“MCM”) 147 by passing parameters relating to the user's 105 requests for data. The MMS 115 manages requests for data from the MCM 147 and acquires the proper data from the enterprise database management systems (“EDMS”) 150. The MCM 147 also controls the functioning of the graphical user interface (“GUI”) 107 which is presented to the user 105 via the web client 110. As practitioners will appreciate, although web client 110 and GUI 107 are depicted in FIG. 1 as logically separate entities for purposes of illustration, web client 100 and GUI 107 need not be physically distinct, i.e., the software portion of the web client 110 may include both a display device and logic capable of presenting the GUI 107 to the user 105. For instance, in one embodiment, the MCM 147 passes graphical user interface instructions in the form of HTML to the web client 110 which includes internet browser technology that renders the GUI 107 on a display.

As discussed in further detail in the process descriptions below, during the exclusion specification stage of the marketing campaign planning process, the MCM 147 reads data from various databases in the EDMS 150 to formulate prompts necessary to guide the user 105 through various policy exclusion methods. In one embodiment, the GUI 107 presented to the user 105 is dynamically constructed, rule driven and data dependant.

EDMS 150 includes elements that manage the enterprise data architecture (including the data contained therein) and elements that deliver data to end users. As practitioners will appreciate, while depicted as a single entity for the purposes of illustration, databases residing within EDMS 150 may represent multiple hardware, software, database, data structure and networking components. FIG. 1 depicts the types of databases that are included in an exemplary embodiment. The exclusions database 155 stores a standardized set of policy rules. The campaign request database 160 stores data specifying marketing campaign structure, attributes and parameters. In one embodiment, campaign request database 160 includes an association to one or more policy exclusions that apply to each marketing campaign. As practitioners will appreciate such an association can be accomplished with a variety of standard data storage techniques. The customer database 165 stores information such as customers and potential customers that may be eligible for marketing campaigns. The campaign eligibility database 170 stores lists of customers that are eligible (for example by virtue of not being restricted by any policy exclusion) for each marketing campaign. As discussed in further detail below, the salt list database 175 stores lists of customers who are specifically targeted for a particular marketing campaign. As practitioners will appreciate, embodiments are not limited to the exemplary databases described above, nor do embodiments necessarily utilize each of the disclosed exemplary databases.

In addition to the components described above, the system 100, the MMS 115 and the EDMS 150 may further include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. A representative list of various databases used herein includes: an exclusions database 155, a salt list database 175, a customer database 165, a campaign request database 160, a campaign eligibility database 170, an external data source 161 and/or other databases that aid in the functioning of the system.

As will be appreciated by one of ordinary skill in the art, one or more system 100 components may be embodied as a customization of an existing system, an add-on product, upgraded software, a stand-alone system (e.g., kiosk), a distributed system, a method, a data processing system, a device for data processing, and/or a computer program product. Accordingly, individual system 100 components may take the form of an entirely software embodiment, an entirely hardware embodiment, or an embodiment combining aspects of both software and hardware. Furthermore, individual system 100 components may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The invention contemplates uses in association with marketing management information systems, business intelligence systems, reporting systems, web services, pervasive and individualized solutions, open source, biometrics, mobility and wireless solutions, commodity computing, grid computing and/or mesh computing. For example, in an embodiment, the web client 110 is configured with a biometric security system that may be used for providing biometrics as a secondary form of identification. The biometric security system may include a transaction device and a reader communicating with the system. The biometric security system also may include a biometric sensor that detects biometric samples and a device for verifying biometric samples. The biometric security system may be configured with one or more biometric scanners, processors and/or systems. A biometric system may include one or more technologies, or any portion thereof, such as, for example, recognition of a biometric. As used herein, a biometric may include a user's voice, fingerprint, facial, ear, signature, vascular patterns, DNA sampling, hand geometry, sound, olfactory, keystroke/typing, iris, retinal or any other biometric relating to recognition based upon any body part, function, system, attribute and/or other characteristic, or any portion thereof.

User 105 may include any individual, business, entity, government organization, software and/or hardware that interact with system 100 to perform tasks such as requesting, retrieving, updating, analyzing, entering or modifying data. User 105 may be, for example, a marketing manager using the system to analyze the customers that would be eligible for a proposed marketing campaign. User 105 may interface with Internet server 125 via any communication protocol, device or method discussed herein, known in the art, or later developed. In one embodiment, user 105 may interact with the MMS 115 via an Internet browser at a web client 110.

Web client 110 comprises any hardware and/or software suitably configured to facilitate requesting, retrieving, updating, analyzing, entering or modifying data such as marketing data or any information discussed herein. Web client 110 includes any device (e.g., personal computer), which communicates (in any manner discussed herein) with the MMS 115 via any network discussed herein. Such browser applications comprise Internet browsing software installed within a computing unit or system to conduct online transactions and communications. These computing units or systems may take the form of a computer or set of computers, although other types of computing units or systems may be used, including laptops, notebooks, hand held computers, set-top boxes, workstations, computer-servers, main frame computers, mini-computers, PC servers, pervasive computers, network sets of computers, and/or the like. Practitioners will appreciate that the web client 110 may or may not be in direct contact with the MMS 115. For example, the web client 110 may access the services of the MMS 115 through another server, which may have a direct or indirect connection to Internet server 125.

As those skilled in the art will appreciate, the web client 110 includes an operating system (e.g., Windows NT, 95/98/2000, OS2, UNIX, Linux, Solaris, MacOS, etc.) as well as various conventional support software and drivers typically associated with computers. Web client 110 may include any suitable personal computer, network computer, workstation, minicomputer, mainframe, mobile device or the like. Web client 110 can be in a home or business environment with access to a network. In an embodiment, access is through a network or the Internet through a commercially available web-browser software package.

Web client 110 may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., Gilbert Held, Understanding Data Communications (1996), which is hereby incorporated by reference. It is noted that the network may be implemented as other types of networks, such as an interactive television (ITV) network.

Firewall 120, as used herein, may comprise any hardware and/or software suitably configured to protect the MMS 115 components from users of other networks. Firewall 120 may reside in varying configurations including stateful inspection, proxy based and packet filtering, among others. Firewall 120 may be integrated as software within Internet server 125, any other system components, or may reside within another computing device or may take the form of a standalone hardware component.

Internet server 125 may include any hardware and/or software suitably configured to facilitate communications between the web client 110 and one or more MMS 115 components. Further, Internet server 125 may be configured to transmit data to the web client 110 within markup language documents. As used herein, “data” may include encompassing information such as commands, queries, files, data for storage, and/or the like in digital or any other form. Internet server 125 may operate as a single entity in a single geographic location or as separate computing components located together or in separate geographic locations.

Internet server 125 may provide a suitable web site or other Internet-based graphical user interface, which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, InterBase, etc., may be used to provide an Active Data Object (ADO) compliant database management system.

Any of the communications, inputs, storage, databases or displays discussed herein may be facilitated through a web site having web pages. The term “web page” as it is used herein is not meant to limit the type of documents and applications that may be used to interact with the user. For example, a typical web site may include, in addition to standard HTML documents, various forms, Java applets, JavaScript, active server pages (ASP), common gateway interface scripts (CGI), extensible markup language (XML), dynamic HTML, cascading style sheets (CSS), helper applications, plug-ins, and/or the like. A server may include a web service that receives a request from a web server, the request including a URL (http://yahoo.com/stockquotes/ge) and an internet protocol (“IP”) address. The web server retrieves the appropriate web pages and sends the data or applications for the web pages to the IP address. Web services are applications that are capable of interacting with other applications over a communications means, such as the Internet. Web services are typically based on standards or protocols such as XML, SOAP, WSDL and UDDI. Web services methods are well known in the art, and are covered in many standard texts. See, e.g., Alex Nghiem, IT Web Services: A Roadmap for the Enterprise (2003), hereby incorporated by reference.

Application server 145 may include any hardware and/or software suitably configured to serve applications and data to a connected web client 110. Like Internet server 125, the application server 145 may communicate with any number of other servers, databases and/or components through any means known in the art. Further, the application server 145 may serve as a conduit between the web client 110 and the various systems and components of the MMS 115. Internet server 125 may interface with the application server 145 through any means known in the art including a LAN/WAN, for example. Application server 145 may further invoke software modules such as the MCM 147 in response to user 105 requests.

MCM 147 may include any hardware and/or software suitably configured to receive requests from the web client 110 via Internet server 125 and the application server 145. MCM 147 is further configured to process requests, construct database queries, and/or execute queries against EDMS 150 databases, external data sources and temporary databases, as well as exchange data with other application modules (not pictured). In one embodiment, the MCM 147 may be configured to interact with other system 100 components to perform complex calculations, retrieve additional data, format data into reports, create XML representations of data, construct markup language documents, and/or the like. Moreover, the MCM 147 may reside as a standalone system or may be incorporated with the application server 145 or any other MMS 115 component as program code.

In order to control access to the application server 145 or any other component of the MMS 115, Internet server 125 may invoke an authentication server 130 in response to user 105 submissions of authentication credentials received at Internet server 125. Authentication server 130 may include any hardware and/or software suitably configured to receive authentication credentials, encrypt and decrypt credentials, authenticate credentials, and/or grant access rights according to pre-defined privileges attached to the credentials. Authentication server 130 may grant varying degrees of application and data level access to users based on information stored within the user database 140.

Any database depicted or implied by FIG. 1 may include any hardware and/or software suitably configured to facilitate storing identification, authentication credentials, and/or user permissions. One skilled in the art will appreciate that system 100 may employ any number of databases in any number of configurations. Further, any databases discussed herein may be any type of database, such as relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of the invention, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In an embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the system by multiple and unrelated owners of the data sets. For example, a first data set which may be stored may be provided by a first party, a second data set which may be stored may be provided by an unrelated second party, and yet a third data set which may be stored, may be provided by a third party unrelated to the first and second parties. Each of the three data sets in this example may contain different information that is stored using different data storage formats and/or techniques. Further, each data set may contain subsets of data that also may be distinct from other subsets.

As stated above, in various embodiments of system 100, the data can be stored without regard to a common format. However, in one embodiment of the invention, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand-alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand-alone device, the appropriate option for the action to be taken. System 100 contemplates a data storage arrangement wherein the header or trailer, or header or trailer history, of the data is stored on the transaction instrument in relation to the appropriate data.

One skilled in the art will also appreciate that, for security reasons, any databases, systems, devices, servers or other components of system 100 may consist of any combination thereof at a single location or at multiple locations, wherein each database or system includes any of various suitable security features, such as firewalls, access codes, encryption, decryption, compression, decompression, and/or the like.

The EDMS 150 may be interconnected to an external data source 161 (for example, to obtain data from a vendor) via a second network, referred to as the external gateway 163. The external gateway 163 may include any hardware and/or software suitably configured to facilitate communications and/or process transactions between the EDMS 150 and the external data source 161. Interconnection gateways are commercially available and known in the art. External gateway 163 may be implemented through commercially available hardware and/or software, through custom hardware and/or software components, or through a combination thereof. External gateway 163 may reside in a variety of configurations and may exist as a standalone system or may be a software component residing either inside EDMS 150, the external data source 161 or any other known configuration. External gateway 163 may be configured to deliver data directly to system 100 components (such as MCM 147) and to interact with other systems and components such as EDMS 150 databases. In one embodiment, the external gateway 163 may comprise web services that are invoked to exchange data between the various disclosed systems. The external gateway 163 represents existing proprietary networks that presently accommodate data exchange for data such as financial transactions, customer demographics, billing transactions and the like. The external gateway 163 is a closed network that is assumed to be secure from eavesdroppers.

The invention may be described herein in terms of functional block components, screen shots, optional selections and various processing steps. It should be appreciated that such functional blocks may be realized by any number of hardware and/or software components configured to perform the specified functions. For example, system 100 may employ various integrated circuit components, e.g., memory elements, processing elements, logic elements, look-up tables, and/or the like, which may carry out a variety of functions under the control of one or more microprocessors or other control devices. Similarly, the software elements of system 100 may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that system 100 may employ any number of conventional techniques for data transmission, signaling, data processing, network control, and/or the like. Still further, system 100 could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Practitioners will appreciate that the illustrated steps described herein may comprise in any number of configurations including the use of windows, web pages, web forms, popup windows, prompts and/or the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

Practitioners will appreciate that there are a number of methods for displaying data within a browser-based document. Data may be represented as standard text or within a fixed list, scrollable list, drop-down list, editable text field, fixed text field, pop-up window, and/or the like. Likewise, there are a number of methods available for modifying data in a web page such as, for example, free text entry using a keyboard, selection of menu items, check boxes, option boxes, and/or the like.

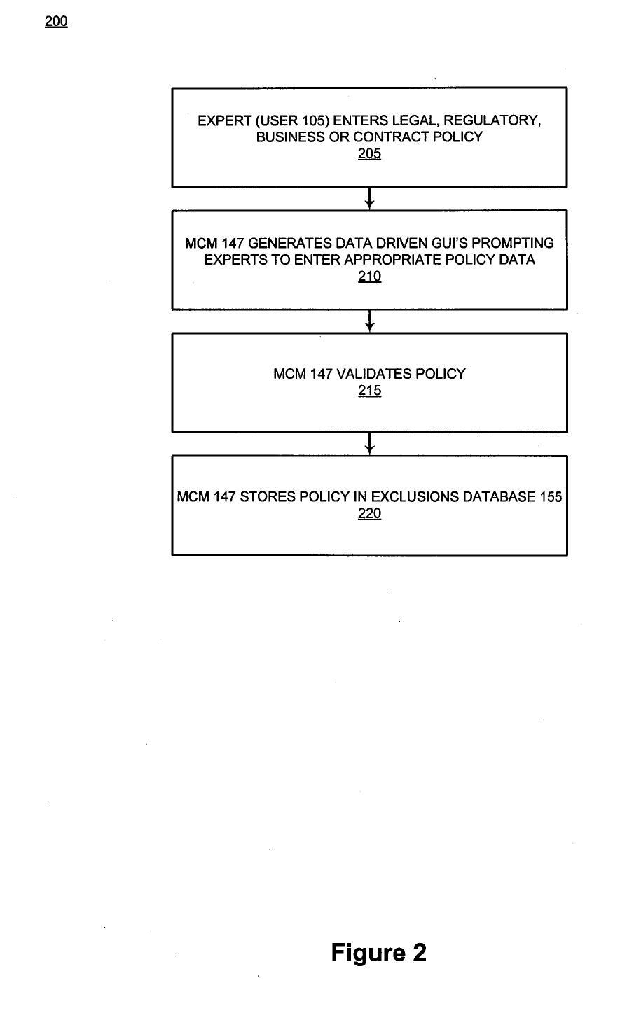

Referring now to the figures, the block system diagrams and process flow diagrams represent mere embodiments of the invention and are not intended to limit the scope of the invention as described herein. For example, the steps recited in FIGS. 2-5 may be executed in any order and are not limited to the order presented. It will be appreciated that the following description makes appropriate references not only to the steps depicted in FIGS. 2-5, but also to the various system components as described above with reference to FIG. 1.

With reference to FIG. 2, a representative process for building a policy exclusion database is shown. Current methods often lack the ability to consistently apply policy exclusions to a marketing campaign. Though marketing campaigns are typically designed and implemented by marketing personnel and/or third-party marketing partners, non-marketing personnel (“policy experts”) typically possess the legal, regulatory, contract and corporate policy knowledge to specify and enforce policies applicable to a marketing campaign. Thus, such policy enforcement is typically a cumbersome and manual process involving extensive coordination between the marketing department and policy experts. In one embodiment, policy experts use a GUI to input, for example, the parameters, applicability limitations, rules and other identifying features of a policy. The invention allows for one expert (or a minimal number of experts) to interpret and implement a policy rather than requiring multiple personnel to interpret the policy in different ways (Step 205). One (or a minimal number of) standardized set of rules is stored in a database which is accessible by the other components of the system (Step 220). In this way, the system provides cost and time savings, and also ensures consistency in policy interpretation.

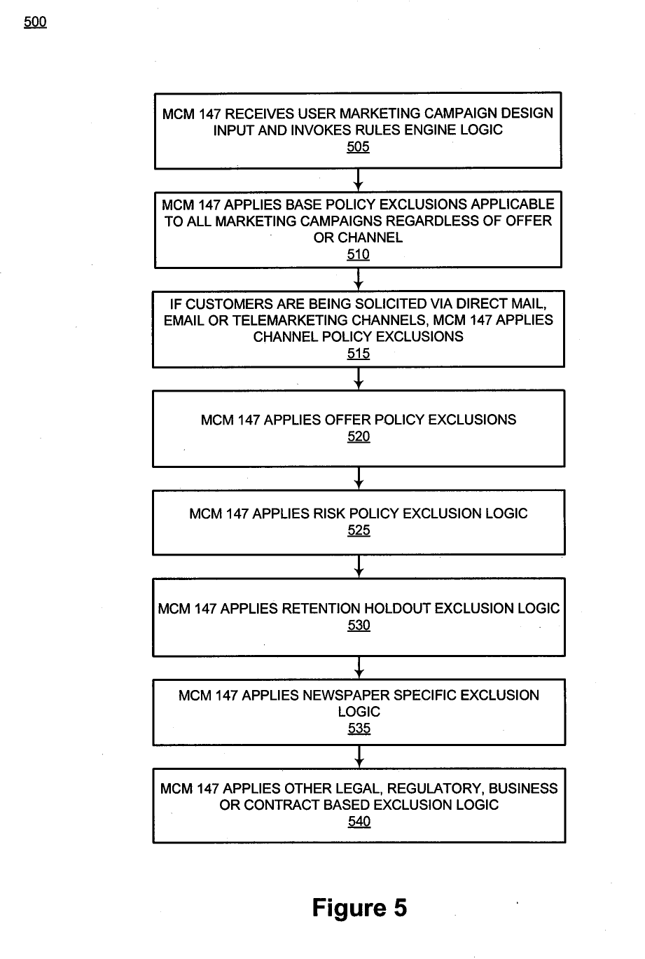

The functioning of the GUI during the exclusion specification stage (Step 210) is controlled by specific methods used for implementing different types of policy exclusions, including methods for implementing the following exemplary exclusions: i) Base Policy Exclusions; ii) Channel Policy Exclusions; iii) Offer Policy Exclusions; iv) Risk Policy Exclusions; v) Retention Holdout Exclusions; vi) Newsletter Specific Exclusions; and/or vii) other legal, regulatory, business or contract based exclusions that enforce policies regarding customer directed marketing activities. A detailed description of each of these examples of policy exclusion is provided below in reference to the process depicted in FIG. 5.

In one embodiment, the process is implemented for a financial transaction account. In this embodiment, additional types of exclusions include, for example: i) National Holdout Exclusion; ii) Open Learning Lab Exclusion and/or iii) other policy exclusions appropriate to the financial transaction industry.

Referring again to FIG. 2, MCM 147 validates a policy using predefined rules and constraints (Step 215). In one embodiment, MCM 147 takes the other policies stored in the exclusion database 155 into account when validating a newly created policy, thereby preventing potential conflicts among the policies stored in the exclusion database 155. MCM 147 stores new policies in the exclusion database 155 (Step 220).

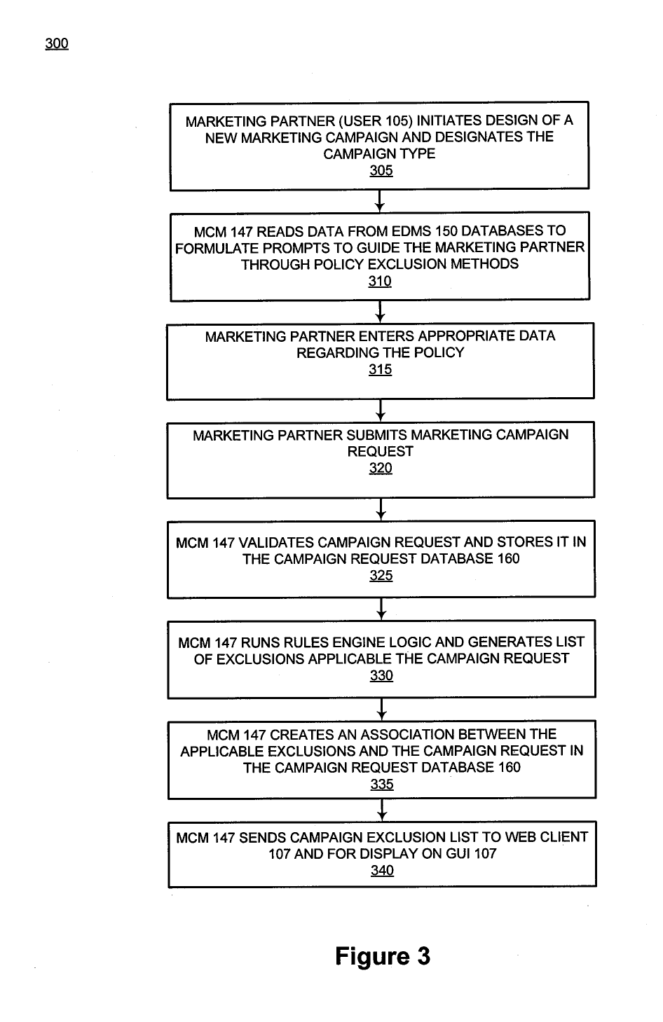

Referring now to FIG. 3, marketing partners often initiate requests for new marketing campaigns but lack the legal, regulatory, contract and policy knowledge to anticipate the data necessary to properly evaluate and enforce the applicable policies. In one embodiment, marketing partners use a GUI to input the data necessary to fully specify a marketing campaign, thereby enabling MCM 147 and the EDMS 150 databases (e.g., exclusion database 155) to determine which policy exclusions should be applied to a marketing campaign. For example, user 105 (e.g., a marketing partner user) initiates the design of a new marketing campaign and specifies the campaign type (Step 305). The applicability of the above-mentioned policy exclusions in marketing campaigns is governed by campaign specific parameters. In one embodiment, the campaign specific parameters may include project type, product type, campaign effective dates, channel selection, answers to specific policy questions and/or other data. The MMS 115 is configured to interface with the user via data forms and prompts (via web client 110 and GUI 107) that vary depending on the information entered. The rules engine executes data driven rules to determine, based upon user input, specific data elements used to evaluate compliance with each policy exclusion in the exclusion database 155.

In one embodiment, MCM 147 reads data from EDMS 150 databases to formulate prompts to guide the marketing partners through various policy exclusion methods (Step 310). For instance, based upon a variety of given information, calculated parameters, deterministic logic, and/or inferential logic, the rules engine may cause the GUI to solicit input of, for example, product type, risk tolerance, campaign objective, campaign effective dates, channel indicator, or other data. This process may include multiple iterations depending upon the complexity of the exclusion policy. For example, one embodiment of the process for determining a policy exclusion may include: i) determine product types affected by the marketing campaign; ii) if any product type is credit related then read data entered by marketing partner to determine if the campaign involves adjusting a line of credit; iii) if the campaign involves adjusting line of credit then acquire data to determine if the campaign involves increasing line of credit; iv) if campaign involves increasing line of credit then read change in line of credit value to determine the amount of increase; v) determine if the amount increase exceeds risk policy threshold; vi) if the amount increase exceeds risk policy threshold then apply risk policy exclusion. In another embodiment, the rules engine may run subsequent to the data being entered. In another embodiment, the rules engine works both interactively during data input and post data entry to complete the exclusion determination logic.

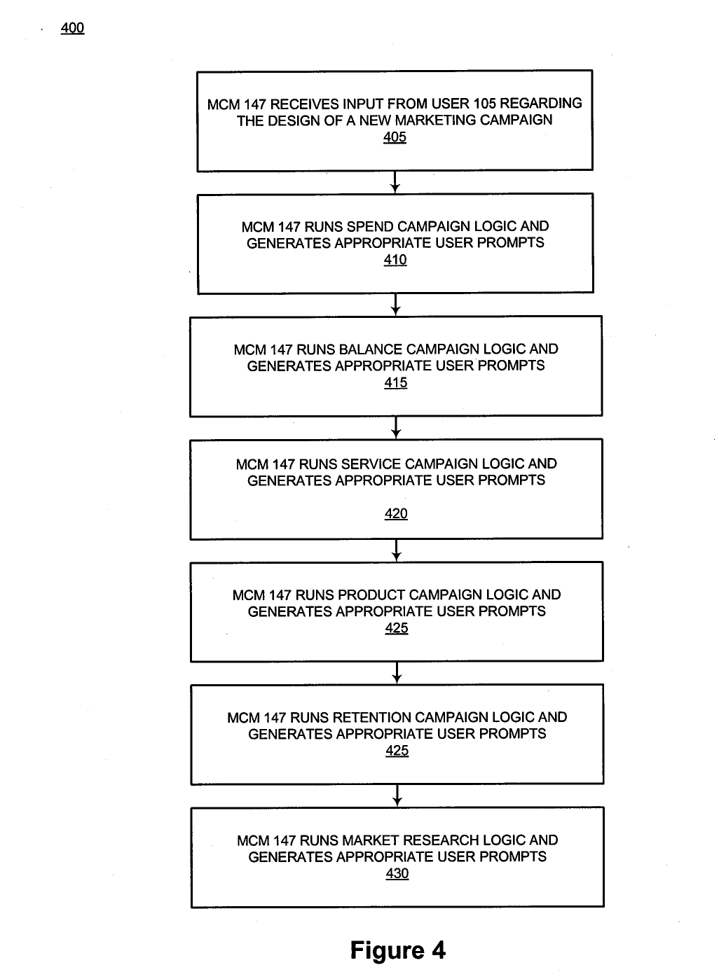

The interface used to specify the parameters of a marketing campaign is not limited to gathering input for any specific type of marketing campaign or strategy. In one embodiment, the tool is configured to implement various types of marketing campaigns. As illustrated further in FIG. 4, the functioning of the graphical user interface during the campaign specification stage is controlled by specific methods used for implementing different types of marketing campaigns, including, for example, methods for implementing the following: i) Spend Campaigns (Step 410)—A spend campaign aims, as one of it objectives, to increase product loyalty by sending offers targeted at increasing transaction volume on a financial transaction instrument product. Examples of spend campaigns can include sending communication about specific benefits/events to encourage spend in general and incentives to customers to use their financial transaction instruments by offering them discounts/bonus points, etc; ii) Balance Campaigns (Step 415)—A balance campaign aims, as one of it objectives, to grow accounts receivables/balance on a financial transaction instrument; iii) Service Campaigns (Step 420)—A service campaign aims, as one of it objectives, to deepen relationships with customers through service enrollments and subscriptions; iv) Product Campaigns (Step 425)—A product campaign aims, as one of it objectives, to acquire new customers by cross-selling/upselling to existing basic and supplementary customers; v) Retention Campaigns (Step 425)—A retention campaign aims, as one of it objectives, to reduce attrition or retain existing customers by using likely attritor (e.g., attrition) and win back types of programs; and vi) Market Research Campaigns (Step 430)—A market research campaign is often used to conduct a market research survey.

In addition to the type of campaign and the specific parameters for each, the MMS 115 also allows the marketing partner user to enter general information about the marketing campaign that enables the system to further identify which policy exclusions apply to the campaign. In one embodiment, this data includes: requested delivery date, drop date, marketing promotion period, type of product, channel, sub-channel, customer list file layout and format, bonusing structures, fulfillment requirements, vendor information and/or additional processing requirements.

One embodiment allows for the automation of “SALT list” processes. The system is used to specify lists of specific individuals to whom the marketing communication is sent, usually used to verify accuracy, timeliness, and adherence to contractual obligations of the external vendor on deliverables specific to the project.

Referring again to FIG. 3, the user 105 enters data as appropriate to respond to the prompts presented via GUI 107 (Step 315) and submits the marketing campaign request (Step 320). MCM 147 validates the campaign request and stores the request and associated data in the campaign request database 160. In one embodiment, MCM 147 does not perform validation before storing the campaign request.

For a fully specified marketing campaign, MCM 147 evaluates all (or a subset) of the policies against the attributes of the marketing campaign to produce a list of policies that are applicable to the campaign (Step 330 and Process 500). Referring now to FIG. 5, MCM 147 invokes rules engine logic (Step 505) for a variety of exemplary policy exclusion types including the following.

Base Policy Exclusions (Step 510)—Typically, base policy exclusions are applicable to all marketing campaigns regardless of offer or channel. That is, general regulations and laws that potentially govern all marketing to consumers. Examples of marketing campaigns where base policy exclusions may apply include acquisition of transaction accounts by cross-selling or up-selling to existing customers, increasing product loyalty by sending offers aimed at increasing spending on the transaction account, growing Accounts Receivable (AR) through Balance Transfer offers, deepen relationship with customers through various service enrollments and subscription offers, etc.

Channel Policy Exclusions (Step 515)—Channel policy exclusions are used, for example, to restrict eligibility for a marketing campaign depending on the marketing channel used, e.g., direct mail, email, telemarketing, etc. For example, a direct mail exclusion may prohibit direct marketing to APO/FPO addresses while an electronic mail exclusion may prohibit marketing solicitation emails to be sent to addresses in the mil domain.

Offer Policy Exclusions (Step 520)—Offer policy exclusions are typically used to restrict eligibility for marketing campaigns depending on the type of offer made to the customer. For example, an offer policy exclusion is typically used to prevent providing a customer incentive to patronize a marketing partner's competitor or to prevent a new marketing program from competing with an existing program.

Risk Policy Exclusions (Step 525)—Risk policy exclusions often restrict eligibility for marketing campaigns depending on the risk level identified for the campaign. For instance, depending on the type of incentive being offered, the business may not want to market a new program to existing customers with delinquent account balances. In one embodiment, identifying and imposing risk policy exclusions are helpful in limiting the number and type of customers who receive solicitations for offers that may increase the financial exposure of the seller or marketing partner.

Retention Holdout Exclusions (Step 530)—Retention holdout exclusions typically serve to restrict eligibility for marketing campaigns where the objective is to retain customers.

Newsletter Specific Exclusions (Step 535)—Newsletter specific exclusions implement newsletter specific customer opt-outs based on customer preference.

Other legal, regulatory, business or contract based exclusions (Step 540) that enforce policies regarding customer directed marketing activities may also be included.

In one embodiment, the process is implemented for a financial transaction account. In this embodiment, additional types of exclusions include, for example: i) National Holdout Exclusion—In national holdout exclusions, a portion of the customer base is segmented into 5 groups in an effort to test campaign-type effectiveness. ii) Open Learning Lab Exclusion—Typically, in this exclusion, small business customers are identified as part of the Learning Lab and suppressed from marketing.

Referring again to FIG. 3, MCM 147 creates an association between the applicable policies and the campaign request in the campaign request database 160 (Step 335). MCM 147 sends campaign exclusion list to web client 110 and for display to the user 105 via GUI 107 (Step 340). In one embodiment, the list of policies that should be applied to a campaign is communicated to the customer database to produce a list of candidates for the customers. This list of eligible customers is stored in the campaign eligibility database 170. In one embodiment, a file is sent via a network to a customer database maintained by a third-party.

While the steps outlined above represent a specific embodiment of the invention, practitioners will appreciate that there are any number of computing algorithms and user interfaces that may be applied to create similar results. The steps are presented for the sake of explanation only and are not intended to limit the scope of the invention in any way.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims of the invention. It should be understood that the detailed description and specific examples, indicating exemplary embodiments of the invention, are given for purposes of illustration only and not as limitations. Many changes and modifications within the scope of the instant invention may be made without departing from the spirit thereof, and the invention includes all such modifications. Corresponding structures, materials, acts, and equivalents of all elements in the claims below are intended to include any structure, material, or acts for performing the functions in combination with other claim elements as specifically claimed. The scope of the invention should be determined by the appended claims and their legal equivalents, rather than by the examples given above. Reference to an element in the singular is not intended to mean “one and only one” unless explicitly so stated, but rather “one or more.” Moreover, where a phrase similar to ‘at least one of A, B, and C’ is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

We claim:

1. A method for determining customer eligibility comprising:
receiving marketing campaign data related to a marketing campaign;
obtaining exclusion data from an exclusion database;
determining a list of exclusions based upon said exclusion data and said marketing campaign data; and,
applying said list of exclusions to a customer database to create a campaign eligibility customer list related to said marketing campaign.

2. The method of claim 1, wherein receiving marketing campaign data comprises prompting for additional data based on previously provided said marketing campaign data.

3. The method of claim 1, wherein receiving marketing campaign data comprises prompting for additional data based on previously provided said marketing campaign data, wherein said additional data comprises at least one of: spend marketing campaign data, balance marketing campaign data, service campaign data, product campaign data, retention campaign data, and market research data.

4. The method of claim 1, wherein said marketing campaign is a transaction account marketing campaign.

5. The method of claim 1, wherein determining a list of exclusions comprises using exclusion policy logic.

6. The method of claim 1 wherein determining a list of exclusions comprises using at least one of: base policy exclusion logic; channel policy exclusion logic; offer policy exclusion logic; risk policy exclusion logic; retention holdout policy exclusion logic; retention holdout policy logic; legal exclusion logic; regulatory exclusion logic; business policy exclusion logic; and contract policy exclusion logic.

7. A machine-readable medium having stored thereon a plurality of instructions for determining customer eligibility, said plurality of instructions when executed by at least one processor, cause said processor to perform a method comprising the steps of:
receiving marketing campaign data related to a marketing campaign;
obtaining exclusion data from an exclusion database;
determining a list of exclusions based upon said exclusion data and said marketing campaign data; and,
applying said list of exclusions to a customer database to create a campaign eligibility customer list related to said marketing campaign.

8. The method of claim 1, further comprising building said exclusion database by:
receiving exclusion data related to an exclusion policy;
prompting for additional data based on said exclusion data; and,
relating said exclusion data and said additional data to marketing campaign data elements to create a policy rule.

9. The method of claim 1, further comprising building said exclusion database by:
receiving exclusion data related to an exclusion policy;
prompting for additional data based on said exclusion data;
relating said exclusion data and said additional data to marketing campaign data elements to create a policy rule;
validating said policy rule; and
storing said policy rule in said exclusion database.

10. A method for creating an exclusion database comprising:
receiving exclusion data related to an exclusion policy;
prompting for additional data based on said exclusion data;
relating said exclusion data and said additional data to marketing campaign data elements to create a policy rule;
validating said policy rule; and
storing said policy rule in said exclusion database.

11. A method for managing a marketing campaign request comprising:
submitting marketing campaign data related to a marketing campaign;
submitting said marketing campaign request;
receiving a policy exclusion list of applicable exclusions for said marketing campaign; and
receiving a customer eligibility file representing customers not excluded by said applicable exclusions.

12. The method of claim 11, further comprising submitting additional data based on previously provided said marketing campaign data.

13. The method of claim 11, further comprising submitting additional data based on previously provided said marketing campaign data, wherein said additional data comprises at least one of: spend marketing campaign data, balance marketing campaign data, service campaign data, product campaign data, retention campaign data, and market research data.

14. The method of claim 11, wherein said marketing campaign is a transaction account marketing campaign.

15. The method of claim 11, wherein receiving said policy exclusion list comprises receiving said policy exclusion list which is based upon exclusion policy logic.

16. The method of claim 11, wherein receiving said policy exclusion list comprises receiving said policy exclusion list which is based upon at least one of: base policy exclusion logic; channel policy exclusion logic; offer policy exclusion logic; risk policy exclusion logic; retention holdout policy exclusion logic; retention holdout policy logic; legal exclusion logic; regulatory exclusion logic; business policy exclusion logic; and contract policy exclusion logic.

17. The method of claim 11, wherein submitting marketing campaign data comprises creating a target customer population list.

18. The method of claim 11, wherein submitting marketing campaign data comprises creating a target customer population list, wherein said customer eligibility file represents customers from said target customer population list not excluded by said applicable exclusions.

19. The method of claim 1 1, wherein said marketing campaign comprises at least one of: market survey; allocation of customer membership rewards; allocation of co-branding points; and crediting a customer transaction account.

20. The method of claim 11, further comprising receiving a status of said marketing campaign request.
